(19) United States
(12) Patent Application Publication
(10) Pub. No.: US 2022/0393467 A1
(43) Pub. Date: Dec. 8, 2022

(54) METHOD AND SYSTEM FOR ENERGY SCHEDULING OF SHARED ENERGY STORAGE CONSIDERING DEGRADATION COST OF ENERGY STORAGE

(71) Applicant: Hefei University of Technology, Hefei (CN)

(72) Inventors: Kaile ZHOU, Hefei (CN); Zenghui ZHANG, Hefei (CN); Tao DING, Hefei (CN)

(21) Appl. No.: 17/886,669

(22) Filed: Aug. 12, 2022

(30) Foreign Application Priority Data
May 6, 2022 (CN) 202210487382.X

(51) Int. Cl. H02J 3/00; H02J 3/28

(52) U.S. Cl. CPC H02J 3/008; H02J 3/004; H02J 3/28; H02J 3/003; G06Q 50/06

(57) ABSTRACT

A method and a system for energy scheduling of shared energy storage considering degradation cost of energy storage. Provided herein relates to energy scheduling for multiple microgrids. The method includes: acquiring energy data of each of microgrids in a multi-microgrid system of shared energy storage; establishing a peer-to-peer trading model between each of the microgrids; establishing a shared energy storage trading model between the multi-microgrid system and the shared energy storage device thereof; establishing a utility grid trading model between the multi-microgrid system and the utility grid thereof; and based on the peer-to-peer trading model, the shared energy storage trading model and the utility grid trading model, setting an objective of minimizing a total operating cost of the multi-microgrid system, and solving an objective function corresponding to the objective to acquire power data of each of the microgrids at each stage.

### CROSS-REFERENCE TO RELATED APPLICATIONS

This application claims the benefit of priority from Chinese Patent Application No. 202210487382.X, filed on May 6, 2022. The content of the aforementioned application, including any intervening amendments thereto, is incorporated herein by reference in its entirety.

### TECHNICAL FIELD

This application relates to energy scheduling for multiple microgrids, and more particularly to a method and a system for energy scheduling of shared energy storage considering degradation cost of energy storage.

### BACKGROUND

As the energy storage devices are applied more widely, new energy storage business models represented by energy sharing have attracted more and more attention, especially in the multi-microgrid system integrated with a large number of renewable energy sources. This is because energy sharing can not only significantly improve the utilization rate of energy storage, but also reduce the overall electricity cost of a single microgrid and a multi-microgrid system. Moreover, with regard to the energy scheduling technologies of multi-microgrid system based on energy sharing, the energy scheduling strategy can be clarified in advance to guide the day-ahead scheduling of the multi-microgrid system, so as to further improve the energy utilization rate of the multi-microgrid system and save the cost of the multi-microgrid system.

At present, the energy sharing technology among microgrids is mainly implemented by sharing energy via peer-to-peer energy trading, that is, each microgrid itself acts as an energy trading subject to perform the energy trading, or sharing energy via shared energy storage, that is, energy trading is performed between each microgrid and the shared energy storage devices, and sharing energy on the basis of peer-to-peer energy trading and further by shared energy storage, thereby optimizing the energy scheduling of the multi-microgrid system.

However, regarding the method for sharing energy via peer-to-peer energy trading, it just ensures energy surpluses to be consumed or satisfy energy shortages, and the sharing rate in the energy sharing needs to be improved. In addition, regarding method for sharing energy via shared energy storage, because the physical distance between the microgrid and the shared energy storage exists, each energy transmission will be accompanied with the energy storage battery loss resulted from charging and discharging and the line transmission loss. Regarding method for sharing energy on the basis of peer-to-peer energy trading and shared energy storage, it still struggles with energy loss and low energy utilization rate. In conclusion, the existing methods for sharing energy has low energy utilization rate, such that the energy scheduling of the multi-microgrid system based on the existing energy sharing methods has the potential to improve the energy utilization rate. Moreover, in the current energy scheduling technologies based on shared energy storage, the uncertainty of renewable energy sources and the energy storage loss are rarely considered, which is not consistent with the actual operation of the multi-microgrid system, and thus the results of the energy scheduling also have the potential to be improved.

### SUMMARY

An objective of this application is to provide a method and a system for energy scheduling of shared energy storage considering degradation cost of energy storage to overcome the problem of low accuracy existing in the current energy scheduling technologies of multi-microgrid system based on energy sharing.

In order to achieve those objectives, technical solutions of this application are described as follows.

In a first aspect, this application provides a method for energy scheduling of shared energy storage considering degradation cost of energy storage, comprising: building a multi-microgrid system of shared energy storage; wherein the multi-microgrid system of shared energy storage comprises microgrids, at least one shared energy storage device and at least one utility grid; wherein the microgrids are provided with independent energy storage devices; the microgrids are respectively connected to the at least one utility grid; and the microgrids are respectively connected to the at least one shared energy storage;

acquiring energy data of each of the microgrids in the multi-microgrid system of shared energy storage; based on the energy data of each of the microgrids in the multi-microgrid system of shared energy storage, establishing a peer-to-peer trading model between each of the microgrids;

based on the peer-to-peer trading model, establishing a shared energy storage trading model between the multi-microgrid system of shared energy storage and the at least one shared energy storage device;

based on the shared energy storage trading model, establishing a utility grid trading model between the multi-microgrid system of shared energy storage and the at least one utility grid; and

setting an objective of minimizing a total operating cost of the multi-microgrid system of shared energy storage; based on the peer-to-peer trading model, the shared energy storage trading model and the utility grid trading model, solving an objective function corresponding to the objective to acquire power data of each of the microgrids at each stage; wherein the total operating cost of the multi-microgrid system of shared energy storage comprises a degradation cost of an energy storage battery in each of the microgrids.

In an embodiment, the step of “acquiring energy data of each of the microgrids in the multi-microgrid system of shared energy storage” further comprises:

subtracting load data of a load consumed by a load device from output data of a renewable energy device to determine energy surplus or shortage data of each of the microgrids in the multi-microgrid system of shared energy storage.

In an embodiment, wherein the objective function is expressed as follows:

$$min {\sum }_{n = 1}^{N} {\sum }_{t = 1}^{T} ( {C}_{t}^{b} \cdot {P}_{n , t}^{b} - {C}_{t}^{b} \cdot {P}_{n , t}^{s} ) + {\sum }_{n = 1}^{N} {\sum }_{l = 1}^{{L}_{n}} {C}_{n , l}^{deg} ;$$

wherein Cₜ^{b} indicates an electricity purchase price when trading with the at least one utility grid; Cₜ^{s} indicates an electricity selling price when trading with the at least one utility grid; P_{n,t}^{b} indicates the amount of electricity purchased by a microgrid n from the at least one utility grid at time t; P_{n,t}^{s} indicates the amount of electricity sold by the microgrid n to the at least one utility grid at time t; C_{n,l}^{deg} indicates a degradation cost corresponding to a l-th cycle of the microgrid n; n={1, 2, 3, . . . , N} indicates a serial number of the microgrids; N indicates the total number of the microgrids; and t={1, 2, 3, . . . , T} indicates a time of microgrids trading; and

a constraint of the objective function comprises:

a power balance constraint of the microgrids under an uncertainty of a renewable energy source is expressed as follows:

$${\sum }_{m} {\overline{P}}_{m , n , t}^{ren} - max ( {α}_{m , n , t} \cdot {\hat{P}}_{m , n , t}^{ren} ) \geq {P}_{n , t}^{s} + {P}_{n , t}^{p , s} + {P}_{n , t}^{c h} + {P}_{n , t}^{exp} + {P}_{n , t}^{load} - {P}_{n , t}^{b} - {P}_{n , t}^{p , b} - {P}_{n , t}^{dis} - {P}_{n , t}^{imp} ;$$

wherein P̅_{m,n,t}^{ren} is a predicted output power of a m-th type renewable energy source in the microgrid n at time t; \hat{P}_{m,n,t}^{ren} is a maximum deviation between an actual output power of the m-th type renewable energy source in the microgrid n at time t and the predicted output power of the m-th type renewable energy source in the microgrid n at time t; α_{m,n,t} indicates an uncertainty degree of the m-th type renewable energy source in the microgrid n at time t; P_{n,t}^{p,s} indicates the amount of energy sold in the peer-to-peer trading of the microgrid n at time t; P_{n,t}^{ch} indicates a charge capacity of an energy storage n at time t; P_{n,t}^{exp} indicates the amount of electricity of the microgrid n exported to shared energy storage at time t; P_{n,t}^{imp} indicates the amount of electricity of the microgrid n imported from the shared energy storage at time t; P_{n,t}^{load} indicates a load demand of the microgrid n at time t; P_{n,t}^{b} indicates the amount of electricity purchased by a microgrid n from the at least one utility grid during time t; P_{n,t}^{p,b} indicates the amount of energy purchased in the peer-to-peer trading of the microgrid n at time t; and P_{n,t}^{dis} indicates a discharge capacity of the energy storage n at time t.

In an embodiment, an equation for calculating the degradation cost C_{n,l}^{deg} is expressed as follows:

$${C}_{n , l}^{deg} = {β}_{n , l} \cdot ( {P}_{n , l}^{c h} + {P}_{n , l}^{dis} ) ;$$

$${β}_{n , l} = \frac{{C}_{n}}{2 {E}_{n} \cdot {N}_{n . l}} ;$$

$${C}_{n} = {c}_{1} \cdot {E}_{n} + {c}_{2} \cdot {P}_{n}^{max} + {m}_{1} \cdot {E}_{n} + {m}_{2} \cdot {P}_{n}^{max} ;$$

wherein β_{n,l} is a degradation coefficient corresponding to the l-th cycle of the microgrid n; P_{n,l}^{ch} is a total charging power corresponding to the l-th cycle of the microgrid n; P_{n,l}^{dis} is a total discharging power corresponding to the l-th cycle of the microgrid n; Cₙ is a total cost of the energy storage battery; Eₙ is a total capacity of the energy storage n; N_{n,l} is a maximum number of cycles of the energy storage battery in the microgrid n at a depth of discharge DOD_{n,l}; c₁ indicates a cost per unit capacity; c₂ indicates a cost per unit power; m₁ indicates a maintenance cost per unit capacity; m₂ indicates a maintenance cost per unit power; and Pₙ^{max} indicates an upper limit of a charging and discharging power of the energy storage battery in the microgrid n.

In a second aspect, this application provides a system for energy scheduling of shared energy storage considering degradation cost of energy storage, comprising:

a data acquisition and processing module;

a peer-to-peer trading module;

a shared energy storage trading module;

a utility grid trading module; and

an energy scheduling module;

wherein the data acquisition and processing module is configured to acquire energy data of each of microgrids in a pre-built multi-microgrid system of shared energy storage;

the peer-to-peer trading module is configured to establish a peer-to-peer trading model between each of the microgrids based on the energy data of each of the microgrids in the pre-built multi-microgrid system of shared energy storage;

the shared energy storage trading module is configured to establish a shared energy storage trading model between the pre-built multi-microgrid system of shared energy storage and a shared energy storage device based on the peer-to-peer trading model;

the utility grid trading module is configured to establish a utility grid trading model between the pre-built multi-microgrid system of shared energy storage and a utility grid based on the shared energy storage trading model; and

the energy scheduling module is configured to set an objective of minimizing a total operating cost of the pre-built multi-microgrid system of shared energy storage, and solve an objective function corresponding to the objective to acquire power data of each of microgrids at each stage based on the peer-to-peer trading model, the shared energy storage trading model and the utility grid trading model; wherein the total operating cost of the pre-built multi-microgrid system of shared energy storage comprises a degradation cost of the energy storage battery in each of the microgrids.

In an embodiment, the pre-built multi-microgrid system of shared energy storage comprises the microgrids, at least one shared energy storage device and at least one utility grid; wherein the microgrids are provided with independent energy storage devices; the microgrids are respectively connected to the at least one utility grid; and the microgrids are respectively connected to the at least one shared energy storage.

In an embodiment, the data acquisition and processing module is further configured to subtract load data of a load consumed by a load device from output data of a renewable energy device to determine energy surplus or shortage data of each of the microgrids in the pre-built multi-microgrid system of shared energy storage.

In an embodiment, the objective function is expressed as follows:

$$min {\sum }_{n = 1}^{N} {\sum }_{t = 1}^{T} ( {C}_{t}^{b} \cdot {P}_{n , t}^{b} - {C}_{t}^{b} \cdot {P}_{n , t}^{s} ) + {\sum }_{n = 1}^{N} {\sum }_{l = 1}^{{L}_{n}} {C}_{n , l}^{deg} ;$$

wherein Cₜ^{b} indicates an electricity purchase price when trading with the at least one utility grid; Cₜ^{s} indicates an electricity selling price when trading with the at least one utility grid; P_{n,t}^{b} indicates the amount of electricity purchased by a microgrid n from the at least one utility grid at time t; P_{n,t}^{b} indicates the amount of electricity sold by the microgrid n to the at least one utility grid at time t; C_{n,l}^{deg} indicates a degradation cost corresponding to a l-th cycle of the microgrid n; n={1, 2, 3, . . . , N} indicates a serial number of the microgrids; N indicates the total number of the microgrids; and t={1, 2, 3, . . . , T} indicates a time of microgrids trading; and

a constraint of the objective function comprises:

a power balance constraint of the microgrids under an uncertainty of a renewable energy source is expressed as follows:

$${\sum }_{m} {\overline{P}}_{m , n , t}^{ren} - max ( {α}_{m , n , t} \cdot {\hat{P}}_{m , n , t}^{ren} ) \geq {P}_{n , t}^{s} + {P}_{n , t}^{p , s} + {P}_{n , t}^{c h} + {P}_{n , t}^{exp} + {P}_{n , t}^{load} - {P}_{n , t}^{b} - {P}_{n , t}^{p , b} - {P}_{n , t}^{dis} - {P}_{n , t}^{imp} ;$$

wherein P̅_{m,n,t}^{ren} is a predicted output power of a m-th type renewable energy source in the microgrid n at time t; \hat{P}_{m,n,t}^{ren} is a maximum deviation between an actual output power of the m-th type renewable energy source in the microgrid n at time t and the predicted output power of the m-th type renewable energy source in the microgrid n at time t; α_{m,n,t} indicates an uncertainty degree of the m-th type renewable energy source in the microgrid n at time t; P_{n,t}^{p,s} indicates the amount of energy sold in the peer-to-peer trading of the microgrid n at time t; P_{n,t}^{ch} indicates a charge capacity of an energy storage n at time t; P_{n,t}^{exp} indicates the amount of electricity of the microgrid n exported to shared energy storage at time t; P_{n,t}^{imp} indicates the amount of electricity of the microgrid n imported from the shared energy storage at time t; P_{n,t}^{load} indicates a load demand of the microgrid n at time t; P_{n,t}^{b} indicates the amount of electricity purchased by a microgrid n from the at least one utility grid during time t; P_{n,t}^{b} indicates the amount of energy purchased in the peer-to-peer trading of the microgrid n at time t; and P_{n,t}^{dis} indicates a discharge capacity of the energy storage n at time t.

In an embodiment, an equation for calculating the degradation cost C_{n,l}^{deg} is expressed as follows:

$${C}_{n , l}^{deg} = {β}_{n , l} \cdot ( {P}_{n , l}^{c h} + {P}_{n , l}^{dis} ) ;$$

$${β}_{n , l} = \frac{{C}_{n}}{2 {E}_{n} \cdot {N}_{n . l}} ;$$

$${C}_{n} = {c}_{1} \cdot {E}_{n} + {c}_{2} \cdot {P}_{n}^{max} + {m}_{1} \cdot {E}_{n} + {m}_{2} \cdot {P}_{n}^{max} ;$$

wherein β_{n,l} is a degradation coefficient corresponding to the l-th cycle of the microgrid n; P_{n,l}^{ch} is a total charging power corresponding to the l-th cycle of the microgrid n; P_{n,l}^{dis} is a total discharging power corresponding to the l-th cycle of the microgrid n; Cₙ is a total cost of the energy storage battery; Eₙ is a total capacity of the energy storage n; N_{n,l} is a maximum number of cycles of the energy storage battery in the microgrid n at a depth of discharge DOD_{n,l}; c₁ indicates a cost per unit capacity; c₂ indicates a cost per unit power; m₁ indicates a maintenance cost per unit capacity; m₂ indicates a maintenance cost per unit power; and Pₙ^{max} indicates an upper limit of a charging and discharging power of the energy storage battery in the microgrid n.

Compared with the prior art, this application has the following beneficial effects.

1. Based on an energy storage sharing framework of the pre-built multi-microgrid system, energy data of each of the microgrids in the multi-microgrid system of shared energy storage is acquired, and a peer-to-peer trading model between each of the microgrids is established. A shared energy storage trading model between the multi-microgrid system of shared energy storage and the shared energy storage device thereof is established. A utility grid trading model between the multi-microgrid system of shared energy storage and the utility grid thereof is established. An objective of minimizing a total operating cost of the multi-microgrid system of shared energy storage is set. Based on the peer-to-peer trading model, the shared energy storage trading model and the utility grid trading model, an objective function corresponding to the objective is solved to acquire power data of each of the microgrids at each stage. Regarding this application, the energy loss resulted from the line transmission in the multi-microgrid system of shared energy storage and the degradation cost of the energy storage battery in the microgrid during the cycle process are taken into consideration, which is more consistent with the actual operation of shared energy storage, and thus the results of the energy scheduling of shared energy storage are more accurate.

2. In this application, a multi-microgrid system of shared energy storage us built. The multi-microgrid system of shared energy storage includes microgrids, at least one shared energy storage device and at least one utility grid. the microgrids are provided with independent energy storage devices. Then, based on the multi-microgrid system, the peer-to-peer trading between the microgrids, the trading between the multi-microgrid system and the shared energy storage device and the trading between the multi-microgrid system and the utility grid are performed in sequence, not only retaining the high efficiency of shared energy storage and high utilization rate of energy storage, but also reducing the energy sharing loss resulted from line transmission by the small scale energy storage of the microgrid, and integrating the advantages of centralized energy storage and distributed energy storage.

3. In this application, the power and degradation coefficient in each cycle are combined to calculate the degradation cost of the energy storage battery during energy storage, which can minimize the loss of the energy storage battery of energy storage. In addition, the degradation cost of the energy storage battery in the microgrid is considered in the subsequent energy scheduling, which makes the energy scheduling results of the shared energy storage more accurate.

4. This application takes the uncertainty of the output of renewable energy source into consideration in a day-ahead energy scheduling of the shared energy storage and manages the uncertainty of the output of renewable energy source into consideration by means of robust optimization, which allows the energy scheduling to be more aligned with the situation under fluctuations of the output of renewable energy sources in real life, so as to make the energy scheduling results of shared energy storage more accurate.

### BRIEF DESCRIPTION OF THE DRAWINGS

In order to make the technical solutions in the embodiments of this disclosure more clear, this disclosure will be described in detail below with reference to the accompanying drawings. Obviously, it should be noted that the embodiments described blow are merely some embodiments of this disclosure. It should be understood for those of ordinary skill in the art that other accompanying drawings can also be obtained by the following accompanying drawings without paying any creative efforts.

FIG. 1 shows a framework of a multi-microgrid system containing shared energy storage according to an embodiment of this application;

FIG. 2 is a flowchart of a method for energy scheduling of shared energy storage considering degradation cost of energy storage according to an embodiment of this application; and

FIG. 3 is a structural diagram of a system for energy scheduling of shared energy storage considering degradation cost of energy storage according to an embodiment of this application.

### DETAILED DESCRIPTION OF EMBODIMENTS

In order to make the objectives, technical solutions and beneficial effects in the embodiments of this disclosure more clear and complete, this disclosure will be described in detail below with reference to the accompanying drawings. Obviously, the embodiments described blow are merely some embodiments of this disclosure. Based on the embodiments of this disclosure, it should be understood that any modifications and replacements made by those skilled in the art without departing from the spirit of this disclosure should fall within the scope of this application defined by the appended claims.

This application provides a method and a system for energy scheduling of shared energy storage considering degradation cost of energy storage to overcome the problem of low accuracy existing in the current energy scheduling technologies of multi-microgrid system based on energy sharing, which improves the energy utilization and saves the cost of microgrid based on accurate results of energy scheduling.

The technical solutions in the embodiments of this application are provided herein to solve the above-mentioned technical problems, and the general idea is illustrated as follows:

In order to not only make the energy scheduling results of the multi-microgrid system of shared energy storage more accurate, but also improve the energy utilization rate and save the cost of microgrid, a new energy storage sharing framework of the multi-microgrid system is provided herein. Based on the energy storage sharing framework, after acquiring the energy data of each of the microgrids in the multi-microgrid system of shared energy storage, a peer-to-peer trading model between each of the microgrids, a shared energy storage trading model between the multi-microgrid system of shared energy storage and the shared energy storage device thereof and a utility grid trading model between the multi-microgrid system of shared energy storage and the utility grid thereof are established in sequence. Based on the above models, an objective of minimizing a total operating cost (the total operating cost takes the degradation cost of the energy storage battery in each of the microgrids into consideration) of the multi-microgrid system of shared energy storage is set, and an objective function corresponding to the objective is solved to acquire power data of each of the microgrids at each stage, so as to realize the accurate energy scheduling of the multi-microgrid of energy sharing.

In order to better understand the above-mentioned technical solutions, this disclosure will be described in detail below with reference to the accompanying drawings and embodiments.

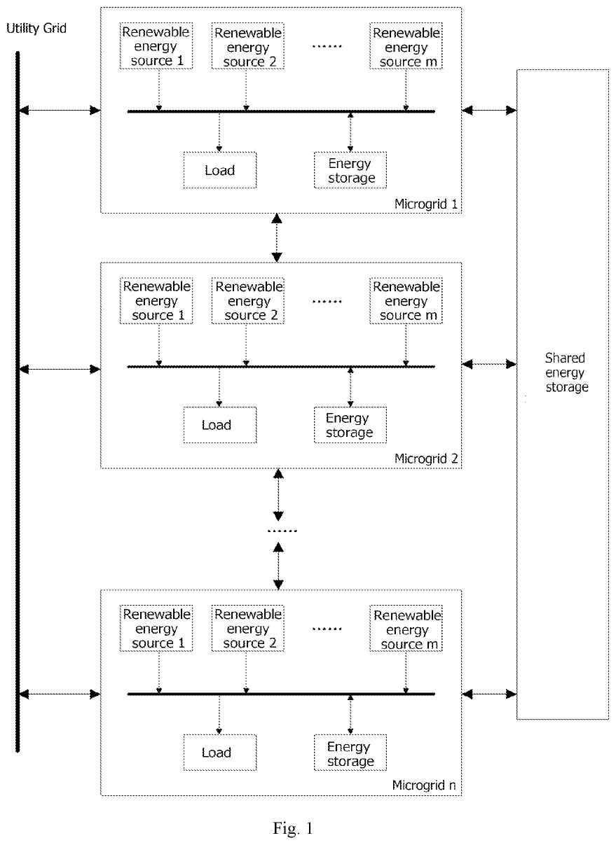

In this application, a new energy storage sharing framework of the multi-microgrid system is constructed, which includes not only the distributed energy storage of each of the microgrids itself, but also the centralized shared energy storage. Referring to an embodiment shown in FIG. 1, the energy storage sharing framework includes a multi-microgrid system including N microgrids. Each of the N microgrids itself includes M types of renewable energy devices to generate energy. Moreover, each of the N microgrids itself includes independent energy storage devices to store energy. In addition, each of the microgrids further includes a load, which consumes the energy. Except for the above structure of each of the microgrids, the multi-microgrid system further includes a shared energy storage device connected to all the microgrids. The shared energy storage device is configured to perform electricity trading with any one of the microgrids, so as to export or import the electricity. Moreover, each of the microgrids in the multi-microgrid system is connected to a utility grid, so as to achieve purchasing or selling of electricity from the utility grid.

Considering that the output of the renewable energy in each of the microgrids is not exactly the same, different microgrids may have energy surplus or energy shortage at the same time, all microgrids as a whole may also have energy surplus or energy shortage, and all microgrids and shared energy storage devices as a whole may also have energy surplus or energy shortage. In this case, under the energy storage sharing framework, the energy sharing of the multi-microgrid system is performed as follows. The peer-to-peer trading of energy among the microgrids is performed. During the peer-to-peer trading, the charging and discharging of the energy storage of each of the microgrids is performed. After the peer-to-peer trading, the microgrid with energy surplus or energy shortage still trades with the shared energy storage device to realize the export or import of the energy. After trading with the shared energy storage device, if one or more of the microgrids in the multi-microgrid system still has energy surplus or energy shortage, the one or more of the microgrids will perform energy trading with the utility grid. Based on the new energy storage sharing framework of the multi-microgrid system, a method and system energy scheduling of shared energy storage considering degradation cost of energy storage are provided herein.

### Embodiment 1

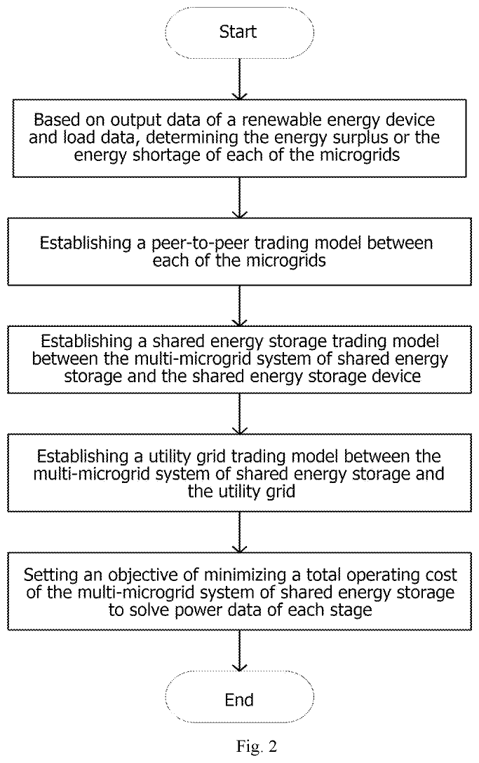

In a first aspect, provided herein is a method for energy scheduling of shared energy storage considering degradation cost of energy storage. Referring to an embodiment shown in FIG. 2, the method is performed as follows.

(S0) A multi-microgrid system of shared energy storage is built. The multi-microgrid system of shared energy storage includes microgrids, at least one shared energy storage device and at least one utility grid. The microgrids are provided with independent energy storage devices. The microgrids are respectively connected to the at least one utility grid. The microgrids are respectively connected to the at least one shared energy storage.

(S1) Energy data of each of the microgrids in the multi-microgrid system of shared energy storage is acquired. Based on the energy data of each of the microgrids in the multi-microgrid system of shared energy storage, a peer-to-peer trading model between each of the microgrids is established.

(S2) Based on the peer-to-peer trading model, a shared energy storage trading model between the multi-microgrid system of shared energy storage and the at least one shared energy storage device is established.

(S3) Based on the shared energy storage trading model, a utility grid trading model between the multi-microgrid system of shared energy storage and the at least one utility grid is established.

(S4) An objective of minimizing a total operating cost of the multi-microgrid system of shared energy storage is set. Based on the peer-to-peer trading model, the shared energy storage trading model and the utility grid trading model, an objective function corresponding to the objective is solved to acquire power data of each of the microgrids at each stage. The total operating cost of the multi-microgrid system of shared energy storage includes a degradation cost of an energy storage battery in each of the microgrids.

In conclusion, based on an energy storage sharing framework of the pre-built multi-microgrid system, energy data of each of the microgrids in the multi-microgrid system of shared energy storage is acquired, and a peer-to-peer trading model between each of the microgrids is established. A shared energy storage trading model between the multi-microgrid system of shared energy storage and the shared energy storage device thereof is established. A utility grid trading model between the multi-microgrid system of shared energy storage and the utility grid thereof is established. An objective of minimizing a total operating cost of the multi-microgrid system of shared energy storage is set. Based on the peer-to-peer trading model, the shared energy storage trading model and the utility grid trading model, an objective function corresponding to the objective is solved to acquire power data of each of the microgrids at each stage. Regarding this application, the degradation cost of each energy storage battery in the microgrid system is taken into consideration, such that the results of the energy scheduling of shared energy storage are more accurate.

The implementation process of a method for energy scheduling of shared energy storage considering energy storage degradation cost in an embodiment of this application will be described in detail below with reference to FIG. 1-2 and the explanation of the steps (S1)-(S4). Specifically, referring to FIG. 1-2, the method is performed as follows.

(S0) A multi-microgrid system of shared energy storage is built. The multi-microgrid system of shared energy storage includes microgrids, at least one shared energy storage device and at least one utility grid. The microgrids are provided with independent energy storage devices. The microgrids are respectively connected to the at least one utility grid. The microgrids are respectively connected to the at least one shared energy storage.

As shown in FIG. 1, a multi-microgrid system of shared energy storage is provided herein. The system includes microgrids (the number of the microgrids is N). Each of the microgrids itself includes M types of renewable energy devices to generate energy and a load to consume energy. Except for the above structure of each of the microgrids, the multi-microgrid system further includes a shared energy storage device connected to all the microgrids. The shared energy storage device is configured to perform electricity trading with any one of the microgrids, so as to export or import the electricity. Moreover, each of the microgrids in the multi-microgrid system is connected to a utility grid, so as to achieve purchasing or selling of electricity from the utility grid.

(S1) Energy data of each of the microgrids in the multi-microgrid system of shared energy storage is acquired. Based on the energy data of each of the microgrids in the multi-microgrid system of shared energy storage, a peer-to-peer trading model between each of the microgrids is established.

Based on the multi-microgrid system of shared energy storage built in step (S0), the peer-to-peer trading between each of the microgrids is performed.

(1) Based on the output data of a renewable energy device and the load data of a load consumed by a load device, the energy surplus or the energy shortage of each of the microgrids is determined.

Each of the microgrids in the multi-microgrid system of shared energy storage itself includes energy generation nodes. The energy generation nodes mainly includes renewable energy output devices. The microgrid is connected to the load, which consumes the energy. Each of the microgrids is provided with an energy storage device. The energy storage device is configured to charge and discharge the microgrid. The energy generation device of each of the microgrids is configured to generate energy and supplies the energy to the microgrid. If the energy generated by the energy generation device is surplus or insufficient, the microgrid exports or imports energy from the energy storage device thereof.

Assuming that the output of the m-th type of renewable energy generation device in a microgrid n at time t is P_{m,n,t}^{ren}, and a load demand of the microgrid n at time t is P_{n,t}^{load}, an energy surplus or an energy shortage of each of the microgrids is allowed to be calculated as follows:

$$\{ \begin{matrix}{P}_{n , t}^{s u r} = {\sum }_{m = 1}^{M} {P}_{m , n , t}^{r e n} - {P}_{n , t}^{l o a d} , {\sum }_{m = 1}^{M} {P}_{m , n , t}^{r e n} - {P}_{n , t}^{l o a d} \geq 0 \\ {P}_{n , t}^{s h o} = {P}_{n , t}^{l o a d} - {\sum }_{m = 1}^{M} {P}_{m , n , t}^{r e n} , {\sum }_{m = 1}^{M} {P}_{m , n , t}^{r e n} - {P}_{n , t}^{l o a d} < 0\end{matrix} ;$$

where P_{n,t}^{sur} indicates an energy surplus of the microgrid n at time t; and P_{n,t}^{sho} indicates an energy shortage of the microgrid n at time t.

(2) Based on the energy surplus or the energy shortage of each of the microgrids, a peer-to-peer trading between each of the microgrids is established.

The peer-to-peer trading model refers a model configured to perform energy transfer between all the microgrids with energy surplus and all the microgrids with energy shortage, and quickly and reasonably distribute the surplus energy to the microgrids with energy shortage.

After completing the export and import of energy of each of the microgrids and the energy storage device thereof, each of the microgrids is in an energy status of energy surplus or energy shortage. The microgrid with energy surplus is allowed to share the surplus energy to the microgrid with energy shortage, that is, the peer-to-peer trading between each of the microgrids is performed.

In the peer-to-peer trading, a charge and discharge of the energy storage device in each of the microgrids is performed, such that an upper limit and a lower limit of the amount of the purchased electricity in the peer-to-peer trading are expressed as follows:

0≤P_{n,t}^{p,b}≤P_{n,t}^{sho}+Pₙ^{ch,max};

an upper limit and a lower limit of the amount of the sold electricity in the peer-to-peer trading are expressed as follows:

0≤P_{n,t}^{p,s}≤P_{n,t}^{sur}+Pₙ^{dis,max};

where P_{n,t}^{p,b} is the amount of energy purchased in the peer-to-peer trading of the microgrid n at time t; P_{n,t}^{p,s} is the amount of energy sold in the peer-to-peer trading of the microgrid n at time t; Pₙ^{ch,max} is a maximum value of the charge of the energy storage of the microgrid n; Pₙ^{dis,max} is a maximum value of the discharge of the energy storage of the microgrid n. Both of the two maximum values are determined by the design criteria of the microgrid.

Considering that a microgrid is not allowed to purchase and sell the electricity at the same time, a constraint is shown as follows:

P_{n,t}^{p,b}·P_{n,t}^{p,s}=0;

The amount of the purchased electricity and the amount of sold electricity in the peer-to-peer trading should be balanced. The total amount of the peer-to-peer trading is the minimum of the total demand of purchased electricity and the total demand of sold electricity, a constraint is shown as follows:

$${\sum }_{n = 1}^{N} {P}_{n , t}^{p , s} \cdot {φ}_{p} = {\sum }_{n = 1}^{N} {P}_{n , t}^{p , b} = min ( {\sum }_{n = 1}^{N} {P}_{n , t}^{p , s} \cdot {φ}_{p} , {\sum }_{n = 1}^{N} {P}_{n , t}^{p , b} ) ;$$

where φₚ indicates a line transmission efficiency between each of the microgrids, and is a constant between 0 and 1, which is related to conditions such as line impedance.

The energy sharing is performed between each microgrid with energy surplus and each microgrid with energy shortage, and a small part of the microgrids with energy surplus or microgrids with energy shortage is left (all of the remaining part of the microgrids have energy surplus or all of the remaining part of the microgrids have energy shortage). The small part of the microgrids will perform energy sharing with the shared energy storage devices. In this step, the energy sharing between the microgrids and the shared energy storage devices is non performed at the beginning, such that the energy loss resulted from the charge and discharge of the energy storage battery and the line transmission during the transmission process is reduced to a certain extent, which improves the energy utilization rate.

(S2) Based on the the peer-to-peer trading model, a shared energy storage trading model between the multi-microgrid system of shared energy storage and the shared energy storage device is established.

The shared energy storage trading model is configured to establish an energy transfer connection between the microgrids with energy surplus/the microgrids with energy shortage and the shared energy storage devices after the peer-to-peer trading between each of the microgrids, so as to perform reasonable energy export/import on the shared energy storage devices.

Since the peer-to-peer trading satisfies the minimum value of energy surplus or energy shortage, all the microgrids will either have energy surplus or energy shortage after the peer-to-peer trading. After the trading amount between the microgrids in the peer-to-peer trading is determined, the microgrids with energy surplus or the microgrids with energy shortage will still trade with the shared energy storage devices. Including the shared energy storage device, the multi-microgrid system includes a total of N+1 energy storage devices (that is, the energy storage device of each of the N microgrids and a shared energy storage device), where n∈N+1, t∈T. When each of the microgrids in the multi-microgrid system performs trading with the shared energy storage device, the charging and discharging of energy storage should satisfy the following relevant constraints.

A. A constraint of an upper limit and a lower limit of charging power and discharging power of the energy storage is expressed as follows:

0≤P_{n,t}^{ch}≤Pₙ^{ch,max};

0≤P_{n,t}^{dis}≤Pₙ^{dis,max};

where P_{n,t}^{ch} indicates a charge capacity of an energy storage n at time t; and P_{n,t}^{dis} indicates a discharge capacity of an energy storage n at time t.

B. The upper limits of the charging power and the discharging power are proportional to the total capacity of the energy storage battery, and a constraint is expressed as follows:

Pₙ^{ch,max}=Pₙ^{dis,max}=k·Eₙ;

where k is a constant between 0 and 1; and Eₙ indicates a total capacity of the energy storage n.

C. Any energy storage device cannot perform charging and discharging at the same time, and a constraint is as follows:

P_{n,t}^{ch}·P_{n,t}^{dis}=0;

D. The charging and discharging process of the energy storage device should maintain energy balance, and a constraint is expressed as follows:

E_{n,t}=E_{n,t-1}+P_{n,t}^{ch}·η^{ch}−P_{n,t}^{dis}/η^{dis};

where E_{n,t} indicates the energy stored by the energy storage n at time t; E_{n,t-1} indicates the energy stored by the energy storage n at time t−1; η^{ch} indicates a charging efficiency of the energy storage device; η^{dis} indicates a discharging efficiency of the energy storage device, and η^{ch} and η^{dis} are both constants between 0 and 1.

E. The energy stored by the energy storage device should be kept within the upper limit thereof and the lower limit thereof, and a constraint is expressed as follows:

Eₙ·SOC≤E_{n,t}≤Eₙ·S̅O̅C̅;

where SOC indicates the lower limit of the state of charge (SOC) of the energy storage device; and S̅O̅C̅ indicates the upper limit of the SOC of the energy storage device.

F. The line transmission efficiency should be taken into consideration in the trading between each of the microgrids and the shared energy storage, and constraints are expressed as follows:

$${\sum }_{n = 1}^{N} {P}_{n , t}^{exp} \cdot {φ}_{p} = {P}_{n + 1 , t}^{c h} ; \\ {\sum }_{n = 1}^{N} {P}_{n , t}^{imp} = {P}_{n + 1 , t}^{dis} \cdot {φ}_{p} ;$$

where P_{n,t}^{exp} indicates the amount of electricity exported by the microgrid n to the shared energy storage at time t; and P_{n,t}^{imp} indicates the amount of electricity imported by the microgrid n from the shared energy storage at time t.

(S3) Based on the shared energy storage trading model, a utility grid trading model between the multi-microgrid system of shared energy storage and the utility grid is established.

After the peer-to-peer trading between each of the microgrids and the energy trading between the microgrid and the shared energy storage device are performed, part of the microgrids have energy surplus or energy shortage. The utility grid trading model is configured to establish the connections between the part of the microgrids and the utility grid, and sell the surplus energy to the utility grid, or purchase energy from the utility grid to supply the energy to the microgrids with energy shortage.

Considering that the amount of energy storage in the shared energy storage device is limited, energy surplus or energy shortage may still occur in part of the microgrids, after the trading between the shared energy storage device and the microgrids, and then the surplus energy or insufficient energy will be satisfied by the trading between the microgrid and the utility grid.

The power of each of the microgrids at any time should be balanced, and a constraint is expressed as follows:

$${P}_{n , t}^{b} + {P}_{n , t}^{p , b} + {P}_{n , t}^{dis} + {P}_{n , t}^{imp} + {\sum }_{m = 1}^{M} {P}_{m , n , t}^{r e n} = {P}_{n , t}^{s} + {P}_{n , t}^{p , s} + {P}_{n , t}^{c h} + {P}_{n , t}^{exp} + {P}_{n , t}^{load} ;$$

where P_{n,t}^{b} indicates the amount of electricity purchased by the microgrid n from the utility grid at time t; and P_{n,t}^{s} indicates the amount of electricity sold by the microgrid n to the utility grid at time t.

(S4) An objective of minimizing a total operating cost of the multi-microgrid system of shared energy storage is set. Based on the peer-to-peer trading model, the shared energy storage trading model and the utility grid trading model, an objective function corresponding to the objective is solved to acquire power data of each of the microgrids at each stage. The total operating cost of the multi-microgrid system of shared energy storage includes a degradation cost of the energy storage battery in each of the microgrids.

1) The calculation of the total operating cost of the multi-microgrid system is performed as follows.

In real life, energy storage batteries gradually degrade in the cycles of charge and discharge during operation. Energy storage battery degradation is affected by various non-operational factors and operating factors. The non-operational factors include depth of discharge (DOD), overcharge or overdischarge, current rate, and the operating factors include voltage level and average state of charge (SOC) of batteries. Regarding these factors, DOD is the most important factor influencing the batteries connected to the grid. Other factors may be limited by the energy storage battery controller or can be ignored, when the batteries are connected to the grid. Thus, it is of great significance for the multi-microgrid based on shared energy storage to take the energy storage battery degradation cost based on DOD into consideration, so as to perform energy scheduling. Therefore, in this embodiment, the total operating cost of the multi-microgrid system considers the degradation cost of the energy storage battery, allowing the optimization results of the energy scheduling of shared energy storage more accurate.

In addition, considering that the shared energy storage device is a part of the multi-microgrid system, the cost of trading between the multi-microgrid system and the shared energy storage device is not included in the objective function. At the same time, the costs and benefits of the peer-to-peer trading of the purchased electricity and the sold electricity between each of the microgrids will cancel each other, such that the peer-to-peer trading of the purchased electricity and the sold electricity between each of the microgrids are not reflected in the objective function.

Based on this, the total operating cost of the multi-microgrid system are only involved with the trading cost between the multi-microgrid system and the utility grid and the degradation cost of the energy storage battery, which is expressed as follows:

$$min {\sum }_{n = 1}^{N} {\sum }_{t = 1}^{T} ( {C}_{t}^{b} \cdot {P}_{n , t}^{b} - {C}_{t}^{b} \cdot {P}_{n , t}^{s} ) + {\sum }_{n = 1}^{N} {\sum }_{l = 1}^{{L}_{n}} {C}_{n , l}^{deg} ; \\ {C}_{n , l}^{deg} = {β}_{n , l} \cdot ( {P}_{n , l}^{c h} + {P}_{n , l}^{dis} ) ;$$

where Cₜ^{b} indicates an electricity purchase price when trading with the utility grid; Cₜ^{s} indicates an electricity selling price when trading with the utility grid; C_{n,l}^{deg} indicates a degradation cost corresponding to a l-th cycle of the microgrid n; P_{n,l}^{ch} indicates a total charging power corresponding to the l-th cycle of the microgrid n; and P_{n,l}^{dis} indicates a total discharging power corresponding to the l-th cycle of the microgrid n.

Specifically, the loss (degradation cost of the energy storage battery) resulted from the energy storage battery charge and discharge cycle is calculated as follows.

In this embodiment, the charge-discharge cycle of the energy storage battery pack is counted by means of rain-flow counting method, including the calculation of the DOD and the number of cycles. Rain-flow counting method is a kind of the cycle counting methods, which can be applied to calculate all load cycles according to the load history, that is, the DOD of the energy storage battery during the charging and discharging cycle and the corresponding number of the cycles of the energy storage battery during the charging and discharging cycle are counted.

It is assumed that the number of cycles of the microgrid n during the charging and discharging process is counted to be Lₙ by means of rain-flow counting method, and the DOD of the microgrid n corresponding to the l-th cycle is recorded to be DOD_{n,l}.

The maximum number of the cycles corresponding to each cycle is expressed as follows:

N_{n,l}=Nₙ·(DOD_{n,l})^{-kp};
where N_{n,l} is the maximum number of cycles of an energy storage battery in the microgrid n at a depth of discharge DOD_{n,l}; Nₙ indicates the number of cycles of the microgrid n under the 100% charge and discharge cycle of the energy storage battery; ₖₚ is an inherent parameter of the energy storage battery, which is related to the types of the energy storage battery.

The degradation coefficient of the energy storage battery is calculated as follows:

$${β}_{n , l} = ; \frac{{C}_{n}}{2 {E}_{n} \cdot {N}_{n , l}} ; {C}_{n} = {c}_{1} \cdot {E}_{n} + {c}_{2} \cdot {P}_{n}^{max} + {m}_{1} \cdot {E}_{n} + {m}_{2} \cdot {P}_{n}^{max} ;$$

where β_{n,l} is a degradation coefficient corresponding to the l-th cycle of the microgrid n; Cₙ is a total cost of the energy storage battery, including the total investment cost and the maintenance cost; c₁ indicates a cost per unit capacity; c₂ indicates a cost per unit power; m₁ indicates a maintenance cost per unit capacity; and m₂ indicates a maintenance cost per unit power.

The charging power corresponding to each cycle is calculated as follows:

$${P}_{n , l}^{c h} = {\sum }_{t ∈ l} {P}_{n , t}^{c h} ;$$

the discharging power corresponding to each cycle is calculated as follows:

$${P}_{n , l}^{dis} = {\sum }_{t ∈ l} {P}_{n , t}^{dis} ;$$

where P_{n,l}^{ch} is a total charging power corresponding to the l-th cycle of the microgrid n; and P_{n,l}^{dis} is a total discharging power corresponding to the l-th cycle of the microgrid n.

The degradation cost corresponding to each cycle of each of the microgrids is calculated as follows:

C_{n,l}^{deg}=β_{n,l}·(P_{n,l}^{ch}+P_{n,l}^{dis});

where C_{n,l}^{deg} indicates a degradation cost corresponding to a l-th cycle of the microgrid n.

2) The uncertainty of the output of the renewable energy sources is processed using the robust optimization.

Considering that the uncertainty of the output of the renewable energy sources (renewable energy sources have the characteristics of volatility and instability during power generation), various prediction methods fail to guarantee complete consistency of the output data in real time. Thus, it is quite necessary to take the uncertainty of the output of the renewable energy sources into consideration in the day-ahead energy scheduling, which allows the method to be more practical in the situations under the fluctuations in the output of the renewable energy sources in real life.

The uncertainty of the renewable energy sources is defined as follows:

$${P}_{m , n , t}^{ren} ∈ [ {\overline{P}}_{m , n , t}^{ren} - {α}_{m , n , t} \cdot {\hat{P}}_{m , n , t}^{ren} , {\hat{P}}_{m , n , t}^{ren} + {α}_{m , n , t} \cdot {\hat{P}}_{m , n , t}^{ren} ] ; \\ 0 \leq {α}_{m , n , t} \leq 1 ; {\sum }_{m} {α}_{m , n , t} = {Γ}_{n , t} ;$$

where P̅_{m,n,t}^{ren} is a predicted output power of a m-th type renewable energy source in the microgrid n at time t; \hat{P}_{m,n,t}^{ren} is a maximum deviation between an actual output power of the m-th type renewable energy source in the microgrid n at time t and the predicted output power of the m-th type renewable energy source in the microgrid n at time t; α_{m,n,t} indicates an uncertainty degree of the m-th type renewable energy source in the microgrid n at time t; when α_{m,n,t}=0, it indicates that there is no uncertainty, such that the output power of the renewable energy source is the predicted power at that time; when α_{m,n,t}=1, it indicates the greatest uncertainty; Γ_{n,t} is a robust parameter, which is configured to control the uncertainty degree of the output power of all renewable energy sources of the microgrid n at time t by limiting the maximum value of

$${\sum }_{m} {α}_{m , n , t} .$$

When the uncertainty of the renewable energy sources is considered, a constraint of power balance of the microgrid is expressed as follows:

$${P}_{n , t}^{b} + {P}_{n , t}^{p , b} + {P}_{n , t}^{dis} + {P}_{n , t}^{imp} + {\sum }_{m = 1}^{M} {P}_{m , n , t}^{r e n} = {P}_{n , t}^{s} + {P}_{n , t}^{p , s} + {P}_{n , t}^{c h} + {P}_{n , t}^{exp} + {P}_{n , t}^{l o a d} ;$$

the constraint of power balance of the microgrid can be converted as follows:

$${\sum }_{m} {\overline{P}}_{m , n , t}^{ren} - max ( {α}_{m , n , t} \cdot {\hat{P}}_{m , n , t}^{ren} ) \geq {P}_{n , t}^{s} + {P}_{n , t}^{p , s} + {P}_{n , t}^{c h} + {P}_{n , t}^{exp} + {P}_{n , t}^{load} - {P}_{n , t}^{b} - {P}_{n , t}^{p , b} - {P}_{n , t}^{d c h} - {P}_{n , t}^{imp} .$$

Due to the nonlinearity of the constraint considering the uncertainty, according to the duality theory, these nonlinear constraints can be converted as follows:

$$\begin{matrix}{\sum }_{m} {\overline{P}}_{m , n , t}^{ren} - ( {λ}_{n , t} \cdot {Γ}_{n , t} + {\sum }_{m} {q}_{m , n , t} ) \geq {P}_{n , t}^{s} + {P}_{n , t}^{p , s} + {P}_{n , t}^{c h} + {P}_{n , t}^{e x p} + {P}_{n , t}^{load} - {P}_{n , t}^{b} - {P}_{n , t}^{p , b} - {P}_{n , t}^{d c h} - {P}_{n , t}^{imp} ; \\ \{ \begin{matrix}{P}_{n , t}^{s u r} = {\sum }_{m} {\overline{P}}_{m , n , t}^{ren} - ( {λ}_{n , t} \cdot {Γ}_{n , t} + {\sum }_{m} {q}_{m , n , t} ) - {P}_{n , t}^{load} , {\sum }_{m} {\overline{P}}_{m , n , t}^{ren} - ( {λ}_{n , t} \cdot {Γ}_{n , t} + {\sum }_{m} {q}_{m , n , t} ) \geq {P}_{n , t}^{load} \\ {P}_{n , t}^{s h o} = {P}_{n , t}^{load} - ( {\sum }_{m} {\overline{P}}_{m , n , t}^{ren} - ( {λ}_{n , t} \cdot {Γ}_{n , t} + {\sum }_{m} {q}_{m , n , t} ) ) , {\sum }_{m} {\overline{P}}_{m , n , t}^{ren} - ( {λ}_{n , t} \cdot {Γ}_{n , t} + {\sum }_{m} {q}_{m , n , t} ) < {P}_{n , t}^{load} ;\end{matrix} \\ {λ}_{n , t} + {q}_{m , n , t} \geq {\hat{P}}_{m , n , t}^{ren} ; \\ {λ}_{n , t} \geq 0 ; \\ {q}_{m , n , t} \geq 0 ;\end{matrix}$$

where λ_{n,t} and q_{m,n,t} are dual variables of the original problem. The original problem refers to the planning problem composed of the original objective function, constraints and nonlinear power balance constraints converted after considering the uncertainty of renewable energy sources.

3) Based on all the converted constraints, the objective function corresponding to the minimum total operating cost of the multi-microgrid system based on the energy storage battery degradation cost is solved to obtain the power data of each of the microgrids in the stages peer-to-peer trading, trading with the shared energy storage device and trading with the utility power grid. And the above power data are the results of the day-ahead energy scheduling of the multi-microgrid system.

In this step, the degradation cost of each energy storage battery of the microgrid during the cycle process is included in the objective function of the multi-microgrid system of shared energy storage (that is, the total operating cost is minimized), and the constraint of the output of the renewable energy sources in each microgrid is taken as one of the constraints of the above objective function, which is more aligned with the real operation of the multi-microgrid system, so as to allow the solved results of the energy scheduling of shared energy storage to be more accurate.

So far, the whole process of the method for energy scheduling of shared energy storage considering degradation cost of energy storage is completed.

### Embodiment 2

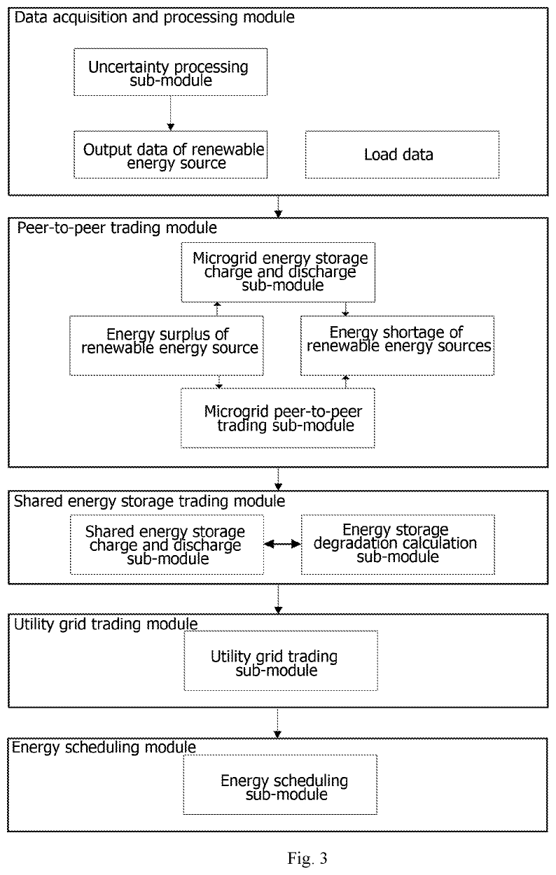

In a second aspect, provided herein is system for energy scheduling of shared energy storage considering degradation cost of energy storage. Referring to an embodiment shown in FIG. 3, the system includes a data acquisition and processing module, a peer-to-peer trading module, a shared energy storage trading module, a utility grid trading module, and an energy scheduling module.

The data acquisition and processing module is configured to acquire energy data of each of microgrids in a pre-built multi-microgrid system of shared energy storage.

The peer-to-peer trading module is configured to establish a peer-to-peer trading model between each of the microgrids based on the energy data of each of the microgrids in the pre-built multi-microgrid system of shared energy storage.

The shared energy storage trading module is configured to establish a shared energy storage trading model between the pre-built multi-microgrid system of shared energy storage and a shared energy storage device based on the peer-to-peer trading model.

The utility grid trading module is configured to establish a utility grid trading model between the pre-built multi-microgrid system of shared energy storage and a utility grid based on the shared energy storage trading model.

The energy scheduling module is configured to set an objective of minimizing a total operating cost of the pre-built multi-microgrid system of shared energy storage, and solve an objective function corresponding to the objective to acquire power data of each of the microgrids at each stage based on the peer-to-peer trading model, the shared energy storage trading model and the utility grid trading model. The total operating cost of the pre-built multi-microgrid system of shared energy storage includes a degradation cost of an energy storage battery in each of the microgrids.

In an embodiment, the pre-built multi-microgrid system of shared energy storage includes the microgrids, at least one shared energy storage device and at least one utility grid. The microgrids are provided with independent energy storage devices; the microgrids are respectively connected to the at least one utility grid; and the microgrids are respectively connected to the at least one shared energy storage.

In an embodiment, the data acquisition and processing module is further configured to subtract load data of a load consumed by a load device from output data of a renewable energy device to determine energy surplus or shortage data of each of the microgrids in the pre-built multi-microgrid system of shared energy storage.

In an embodiment, the objective function is expressed as follows:

$$min {\sum }_{n = 1}^{N} {\sum }_{t = 1}^{T} ( {C}_{t}^{b} \cdot {P}_{n , t}^{b} - {C}_{t}^{b} \cdot {P}_{n , t}^{s} ) + {\sum }_{n = 1}^{N} {\sum }_{l = 1}^{{L}_{n}} {C}_{n , l}^{deg} ;$$

where Cₜ^{b} indicates an electricity purchase price when trading with the utility grid; Cₜ^{s} indicates an electricity selling price when trading with the utility grid; P_{n,t}^{b} indicates the amount of electricity purchased by a microgrid n from the utility grid at time t; P_{n,t}^{s} indicates the amount of electricity sold by the microgrid n to the utility grid at time t; C_{n,l}^{deg} indicates a degradation cost corresponding to a l-th cycle of the microgrid n; n={1, 2, 3, . . . , N} indicates a serial number of the microgrids; N indicates the total number of the microgrids; and t={1, 2, 3, . . . , T} indicates a time of microgrids trading.

A constraint of the objective function includes:

a power balance constraint of the microgrids under an uncertainty of a renewable energy source is expressed as follows:

$${\sum }_{m} {\overline{P}}_{m , n , t}^{r e n} - max ( {α}_{m , n , t} \cdot {\hat{P}}_{m , n , t}^{r e n} ) \geq {P}_{n , t}^{s} + {P}_{n , t}^{p , s} + {P}_{n , t}^{c h} + {P}_{n , t}^{exp} + {P}_{n , t}^{l o a d} - {P}_{n , t}^{b} - {P}_{n , t}^{p , b} - {P}_{n , t}^{dis} - {P}_{n , t}^{imp} ;$$

where P̅_{m,n,t}^{ren} is a predicted output power of a m-th type renewable energy source in the microgrid n at time t; \hat{P}_{m,n,t}^{ren} is a maximum deviation between an actual output power of the m-th type renewable energy source in the microgrid n at time t and the predicted output power of the m-th type renewable energy source in the microgrid n at time t; α_{m,n,t} indicates an uncertainty degree of the m-th type renewable energy source in the microgrid n at time t; P_{n,t}^{p,s} indicates the amount of energy sold in the peer-to-peer trading of the microgrid n at time t; P_{n,t}^{ch} indicates a charge capacity of an energy storage n at time t; P_{n,t}^{exp} indicates the amount of electricity of the microgrid n exported to shared energy storage at time t; P_{n,t}^{imp} indicates the amount of electricity of the microgrid n imported from the shared energy storage at time t; P_{n,t}^{load} indicates a load demand of the microgrid n at time t; P_{n,t}^{b} indicates the amount of electricity purchased by a microgrid n from the utility grid during time t; P_{n,t}^{p,b} indicates the amount of energy purchased in the peer-to-peer trading of the microgrid n at time t; and P_{n,t}^{dis} indicates a discharge capacity of the energy storage n at time t.

In an embodiment, an equation for calculating the degradation cost C_{n,l}^{deg} is expressed as follows:

$${C}_{n , l}^{deg} = {β}_{n , l} \cdot ( {P}_{n , l}^{c h} + {P}_{n , l}^{dis} ) ; \\ {β}_{n , l} = \frac{{C}_{n}}{2 {E}_{n} \cdot {N}_{n , l}} ; \\ {C}_{n} = {c}_{1} \cdot {E}_{n} + {c}_{2} \cdot {P}_{n}^{max} + {m}_{1} \cdot {E}_{n} + {m}_{2} \cdot {P}_{n}^{max} ;$$

where β_{n,l} is a degradation coefficient corresponding to the l-th cycle of the microgrid n; P_{n,l}^{ch} is a total charging power corresponding to the l-th cycle of the microgrid n; P_{n,l}^{dis} is a total discharging power corresponding to the l-th cycle of the microgrid n; Cₙ is a total cost of the energy storage battery; Eₙ is a total capacity of the energy storage n; N_{n,l} is a maximum number of cycles of the energy storage battery in the microgrid n at a depth of discharge DOD_{n,l}; c₁ indicates a cost per unit capacity; c₂ indicates a cost per unit power; m₁ indicates a maintenance cost per unit capacity; m₂ indicates a maintenance cost per unit power; and Pₙ^{max} indicates an upper limit of a charging and discharging power of the energy storage battery in the microgrid n.

It should be understood that the system for energy scheduling of shared energy storage considering degradation cost of energy storage provided herein corresponds to the above-mentioned method for energy scheduling of shared energy storage considering degradation cost of energy storage. The explanation, examples, beneficial effects and other parts of the relevant content of the system can be referred by the corresponding content in the method, and will not be repeated herein.

Compared with the prior art, this application has the following beneficial effects.

1. Based on an energy storage sharing framework of the pre-built multi-microgrid system, energy data of each of the microgrids in the multi-microgrid system of shared energy storage is acquired, and a peer-to-peer trading model between each of the microgrids is established. A shared energy storage trading model between the multi-microgrid system of shared energy storage and the shared energy storage device thereof is established. A utility grid trading model between the multi-microgrid system of shared energy storage and the utility grid thereof is established. An objective of minimizing a total operating cost of the multi-microgrid system of shared energy storage is set. Based on the peer-to-peer trading model, the shared energy storage trading model and the utility grid trading model, an objective function corresponding to the objective is solved to acquire power data of each of the microgrids at each stage. Regarding this application, the energy loss resulted from the line transmission in the multi-microgrid system of shared energy storage and the degradation cost of the energy storage battery in the microgrid during the cycle process are taken into consideration, which is more consistent with the actual operation of shared energy storage, and thus the results of the energy scheduling of shared energy storage are more accurate.

2. In this application, a multi-microgrid system of shared energy storage us built. The multi-microgrid system of shared energy storage includes microgrids, at least one shared energy storage device and at least one utility grid. The microgrids are provided with independent energy storage devices. Then, based on the multi-microgrid system, the peer-to-peer trading between the microgrids, the trading between the multi-microgrid system and the shared energy storage device and the trading between the multi-microgrid system and the utility grid are performed in sequence, not only retaining the high efficiency of shared energy storage and high utilization rate of energy storage, but also reducing the energy sharing loss resulted from line transmission by the small scale energy storage of the microgrid, and integrating the advantages of centralized energy storage and distributed energy storage.

3. In this application, the power and degradation coefficient in each cycle are combined to calculate the degradation cost of the energy storage battery during energy storage, which can not only minimize the loss of the energy storage battery of energy storage. In addition, the degradation cost of the energy storage battery in the microgrid is considered in the subsequent energy scheduling, which makes the energy scheduling results of the shared energy storage more accurate.

4. This application takes the uncertainty of the output of renewable energy source into consideration in a day-ahead energy scheduling of the shared energy storage and manages the uncertainty of the output of renewable energy source into consideration by means of robust optimization, which allows the energy scheduling to be more aligned with the situation under fluctuations of the output of renewable energy sources in real life, so as to make the energy scheduling results of shared energy storage more accurate.

It should be noted that as used herein, relational terms such as “first” and “second” are merely intended to distinguish one entity or operation from another entity or operation, and do not necessarily require or imply such an actual relationship or order between these entities or operations. Furthermore, the term “comprise”, “include”, “contain” or any other variations are intended to encompass a non-exclusive inclusion, such that a process, method, article, or instrument not only includes those listed elements, but also includes those that are not clearly listed, or those elements that are inherent to such a process, method, article, or instrument. If there are no more restrictions, the elements defined by the sentence “comprising . . . ” do not exclude the existence of other identical elements in the process, method, article, or instrument comprising the elements.

Described above are merely described to illustrate the technical solutions of this disclosure, but not intended to limit this disclosure. It should be understood for those of ordinary skill in the art that any modifications of the technical solutions described in the above embodiments or the equivalent replacement of the part of the technical features can be made without departing from the spirit of the application should still fall within the scope of the present application defined by the appended claims.

What is claimed is:

1. A method for energy scheduling of shared energy storage considering degradation cost of energy storage, comprising:
building a multi-microgrid system of shared energy storage; wherein the multi-microgrid system of shared energy storage comprises microgrids, at least one shared energy storage device and at least one utility grid; wherein the microgrids are provided with independent energy storage devices; the microgrids are respectively connected to the at least one utility grid; and the microgrids are respectively connected to the at least one shared energy storage;
acquiring energy data of each of the microgrids in the multi-microgrid system of shared energy storage; based on the energy data of each of the microgrids in the multi-microgrid system of shared energy storage, establishing a peer-to-peer trading model between each of the microgrids;
based on the peer-to-peer trading model, establishing a shared energy storage trading model between the multi-microgrid system of shared energy storage and the at least one shared energy storage device;
based on the shared energy storage trading model, establishing a utility grid trading model between the multi-microgrid system of shared energy storage and the at least one utility grid; and
setting an objective of minimizing a total operating cost of the multi-microgrid system of shared energy storage; based on the peer-to-peer trading model, the shared energy storage trading model and the utility grid trading model, solving an objective function corresponding to the objective to acquire power data of each of the microgrids at each stage; wherein the total operating cost of the multi-microgrid system of shared energy storage comprises a degradation cost of an energy storage battery in each of the microgrids.

2. The method of claim 1, wherein the step of “acquiring energy data of each of the microgrids in the multi-microgrid system of shared energy storage” further comprises:
subtracting load data of a load consumed by a load device from output data of a renewable energy device to determine energy surplus or shortage data of each of the microgrids in the multi-microgrid system of shared energy storage.

3. The method of claim 1, wherein the objective function is expressed as follows:
$$min {\sum }_{n = 1}^{N} {\sum }_{t = 1}^{T} ( {C}_{t}^{b} \cdot {P}_{n , t}^{b} - {C}_{t}^{b} \cdot {P}_{n , t}^{s} ) + {\sum }_{n = 1}^{N} {\sum }_{l = 1}^{{L}_{n}} {C}_{n , l}^{deg} ;$$
wherein Cₜ^{b} indicates an electricity purchase price when trading with the at least one utility grid; Cₜ^{s} indicates an electricity selling price when trading with the at least one utility grid; P_{n,t}^{b} indicates the amount of electricity purchased by a microgrid n from the at least one utility grid at time t; P_{n,t}^{s} indicates the amount of electricity sold by the microgrid n to the at least one utility grid at time t; C_{n,l}^{deg} indicates a degradation cost corresponding to a l-th cycle of the microgrid n; n={1, 2, 3, . . . , N} indicates a serial number of the microgrids; N indicates the total number of the microgrids; and t={1, 2, 3, . . . , T} indicates a time of micro-network trading; and
a constraint of the objective function comprises:
a power balance constraint of the microgrids under an uncertainty of a renewable energy source is expressed as follows:
$${\sum }_{m} {\overline{P}}_{m , n , t}^{ren} - max ( {α}_{m , n , t} \cdot {\hat{P}}_{m , n , t}^{ren} ) \geq {P}_{n , t}^{s} + {P}_{n , t}^{p , s} + {P}_{n , t}^{c h} + {P}_{n , t}^{exp} P + {P}_{n , t}^{load} - {P}_{n , t}^{b} - {P}_{n , t}^{p , b} - {P}_{n , t}^{dis} - {P}_{n , t}^{imp} ;$$
wherein P̅_{m,n,t}^{ren} is a predicted output power of a m-th type renewable energy source in the microgrid n at time t; \hat{P}_{m,n,t}^{ren} is a maximum deviation between an actual output power of the m-th type renewable energy source in the microgrid n at time t and the predicted output power of the m-th type renewable energy source in the microgrid n at time t; α_{m,n,t} indicates an uncertainty degree of the m-th type renewable energy source in the microgrid n at time t; P_{n,t}^{p,s} indicates the amount of energy sold in the peer-to-peer trading of the microgrid n at time t; P_{n,t}^{ch} indicates a charge capacity of an energy storage n at time t; P_{n,t}^{exp} indicates the amount of electricity of the microgrid n exported to shared energy storage at time t; P_{n,t}^{imp} indicates the amount of electricity of the microgrid n imported from the shared energy storage at time t; P_{n,t}^{load} indicates a load demand of the microgrid n at time t; P_{n,t}^{b} indicates the amount of electricity purchased by a microgrid n from the at least one utility grid during time t; P_{n,t}^{p,b} indicates the amount of energy purchased in the peer-to-peer trading of the microgrid n at time t; and P_{n,t}^{dis} indicates a discharge capacity of the microgrid n at time t.

4. The method of claim 3, wherein an equation for calculating the degradation cost C_{n,l}^{deg} is expressed as follows:
$${C}_{n , l}^{deg} = {β}_{n , l} \cdot ( {P}_{n , l}^{c h} + {P}_{n , l}^{dis} ) ;$$
$${β}_{n , l} = \frac{{C}_{n}}{2 {E}_{n} \cdot {N}_{n . l}} ;$$
$${C}_{n} = {c}_{1} \cdot {E}_{n} + {c}_{2} \cdot {P}_{n}^{max} + {m}_{1} \cdot {E}_{n} + {m}_{2} \cdot {P}_{n}^{max} ;$$
wherein β_{n,l} is a degradation coefficient corresponding to the l-th cycle of the microgrid n; P_{n,l}^{ch} is a total charging power corresponding to the l-th cycle of the microgrid n; P_{n,l}^{dis} is a total discharging power corresponding to the l-th cycle of the microgrid n; Cₙ is a total cost of the energy storage battery; Eₙ is a total capacity of the energy storage n; N_{n,l} is a maximum number of cycles of the energy storage battery in the microgrid n at a depth of discharge DOD_{n,l}; c₁ indicates a cost per unit capacity; c₂ indicates a cost per unit power; m₁ indicates a maintenance cost per unit capacity; m₂ indicates a maintenance cost per unit power; and Pₙ^{max} indicates an upper limit of a charging and discharging power of the energy storage battery in the microgrid n.

5. A system for energy scheduling of shared energy storage considering degradation cost of energy storage, comprising:
a data acquisition and processing module;
a peer-to-peer trading module;
a shared energy storage trading module;
a utility grid trading module; and
an energy scheduling module;
wherein the data acquisition and processing module is configured to acquire energy data of each of microgrids in a pre-built multi-microgrid system of shared energy storage;
the peer-to-peer trading module is configured to establish a peer-to-peer trading model between each of the microgrids based on the energy data of each of the microgrids in the pre-built multi-microgrid system of shared energy storage;
the shared energy storage trading module is configured to establish a shared energy storage trading model between the pre-built multi-microgrid system of shared energy storage and a shared energy storage device based on the peer-to-peer trading model;
the utility grid trading module is configured to establish a utility grid trading model between the pre-built multi-microgrid system of shared energy storage and a utility grid based on the shared energy storage trading model; and
the energy scheduling module is configured to set an objective of minimizing a total operating cost of the pre-built multi-microgrid system of shared energy storage, and solve an objective function corresponding to the objective to acquire power data of each of the microgrids at each stage based on the peer-to-peer trading model, the shared energy storage trading model and the utility grid trading model; wherein the total operating cost of the pre-built multi-microgrid system of shared energy storage comprises a degradation cost of an energy storage battery in each of the microgrids.

6. The system of claim 5, wherein the pre-built multi-microgrid system of shared energy storage comprises the microgrids, at least one shared energy storage device and at least one utility grid; wherein the microgrids are provided with independent energy storage devices; the microgrids are respectively connected to the at least one utility grid; and the microgrids are respectively connected to the at least one shared energy storage.

7. The system of claim 5, wherein the data acquisition and processing module is further configured to subtract load data of a load consumed by a load device from output data of a renewable energy device to determine the energy data of each of the microgrids in the pre-built multi-microgrid system of shared energy storage.

8. The system of claim 5, wherein the objective function is expressed as follows:
$$min {\sum }_{n = 1}^{N} {\sum }_{t = 1}^{T} ( {C}_{t}^{b} \cdot {P}_{n , t}^{b} - {C}_{t}^{b} \cdot {P}_{n , t}^{s} ) + {\sum }_{n = 1}^{N} {\sum }_{l = 1}^{{L}_{n}} {C}_{n , l}^{deg} ;$$
wherein Cₜ^{b} indicates an electricity purchase price when trading with the utility grid; Cₜ^{s} indicates an electricity selling price when trading with the utility grid; P_{n,t}^{b} indicates the amount of electricity purchased by a microgrid n from the utility grid at time t; P_{n,t}^{s} indicates the amount of electricity sold by the microgrid n to the utility grid at time t; C_{n,l}^{deg} indicates a degradation cost corresponding to a l-th cycle of the microgrid n; n={1, 2, 3, . . . , N} indicates a serial number of the microgrids; N indicates the total number of the microgrids; and t={1, 2, 3, . . . , T} indicates a time of microgrids trading; and
a constraint of the objective function comprises:
a power balance constraint of the microgrids under an uncertainty of a renewable energy source is expressed as follows:
$${\sum }_{m} {\overline{P}}_{m , n , t}^{ren} - max ( {α}_{m , n , t} \cdot {\hat{P}}_{m , n , t}^{ren} ) \geq {P}_{n , t}^{s} + {P}_{n , t}^{p , s} + {P}_{n , t}^{c h} + {P}_{n , t}^{exp} + {P}_{n , t}^{load} - {P}_{n , t}^{b} - {P}_{n , t}^{p , b} - {P}_{n , t}^{dis} - {P}_{n , t}^{imp} ;$$
wherein P̅_{m,n,t}^{ren} is a predicted output power of a m-th type renewable energy source in the microgrid n at time t; \hat{P}_{m,n,t}^{ren} is a maximum deviation between an actual output power of the m-th type renewable energy source in the microgrid n at time t and the predicted output power of the m-th type renewable energy source in the microgrid n at time t; α_{m,n,t} indicates an uncertainty degree of the m-th type renewable energy source in the microgrid n at time t; P_{n,t}^{p,s} indicates the amount of energy sold in the peer-to-peer trading of the microgrid n at time t; P_{n,t}^{ch} indicates a charge capacity of an energy storage n at time t; P_{n,t}^{exp} indicates the amount of electricity of the microgrid n exported to shared energy storage at time t; P_{n,t}^{imp} indicates the amount of electricity of the microgrid n imported from the shared energy storage at time t; P_{n,t}^{load} indicates a load demand of the microgrid n at time t; P_{n,t}^{b} indicates the amount of electricity purchased by a microgrid n from the utility grid during time t; P_{n,t}^{p,b} indicates the amount of energy purchased in the peer-to-peer trading of the microgrid n at time t; and P_{n,t}^{dis} indicates a discharge capacity of the energy storage n at time t.

9. The system of claim 8, wherein an equation for calculating the degradation cost C_{n,l}^{deg} is expressed as follows:
$${C}_{n , l}^{deg} = {β}_{n , l} \cdot ( {P}_{n , l}^{c h} + {P}_{n , l}^{dis} ) ;$$
$${β}_{n , l} = \frac{{C}_{n}}{2 {E}_{n} \cdot {N}_{n . l}} ;$$
$${C}_{n} = {c}_{1} \cdot {E}_{n} + {c}_{2} \cdot {P}_{n}^{max} + {m}_{1} \cdot {E}_{n} + {m}_{2} \cdot {P}_{n}^{max} ;$$
wherein β_{n,l} is a degradation coefficient corresponding to the l-th cycle of the microgrid n; P_{n,l}^{ch} is a total charging power corresponding to the l-th cycle of the microgrid n; P_{n,l}^{dis} is a total discharging power corresponding to the l-th cycle of the microgrid n; Cₙ is a total cost of the energy storage battery; Eₙ is a total capacity of the energy storage n; N_{n,l} is a maximum number of cycles of the energy storage battery in the microgrid n at a depth of discharge DOD_{n,l}; c₁ indicates a cost per unit capacity; c₂ indicates a cost per unit power; m₁ indicates a maintenance cost per unit capacity; m₂ indicates a maintenance cost per unit power; and Pₙ^{max} indicates an upper limit of a charging and discharging power of the energy storage battery in the microgrid n.
